(19) United States
(12) Patent Application Publication
(10) Pub. No.: US 2026/0363212 A1
(43) Pub. Date: Nov. 19, 2026

(54) ENHANCED DATA ANALYSIS OF REAL-TIME ACTIVITY INTERPRETATION

(71) Applicant: International Business Machines Corporation, Armonk, NY (US)

(72) Inventors: Supal Kanti CHOWDHURY, Kolkata (IN); Anand BHUSHAN, Noida (IN); Subhendu BHATTACHARYA, Kolkata (IN)

(21) Appl. No.: 19/207,659

(22) Filed: May 14, 2025

(51) Int. Cl. A01K 29/00; G06F 40/205; G06V 20/40

(52) U.S. Cl. CPC A01K 29/005; G06F 40/205; G06V 20/46

(57) ABSTRACT

In some implementations, a computer system may receive, from at least two of a wearable device, a sensor, a camera, or a microphone, a multimodal data stream associated with real-time activity. The computer system may identify a pattern of the real-time activity based on the multimodal data stream. The computer system may convert the pattern into a natural language prompt. The computer system may determine an interpretation of the real-time activity using the natural language prompt and a machine learning algorithm. The computer system may output an indication of the interpretation through a user interface.

### BACKGROUND

This disclosure relates to techniques associated with interpreting real-time activity data, such as animal activity and behaviors.

### SUMMARY

Some aspects described herein relate to a computer-implemented method. The method may include receiving, from at least two of a wearable device, a sensor, a camera, or a microphone, a multimodal data stream associated with real-time activity. The method may include identifying a pattern of the real-time activity based on the multimodal data stream. The method may include converting the pattern into a natural language prompt. The method may include determining an interpretation of the real-time activity using the natural language prompt and a machine learning algorithm. The method may include outputting an indication of the interpretation through a user interface.

Some aspects described herein relate to a computer system. The computer system may include a processor set, one or more computer-readable storage media, and program instructions stored on the one or more computer-readable storage media to cause the processor set to perform operations. The operations may include receiving behavioral, auditory, and physiological data of an animal, from a wearable device, a camera, and a microphone. The operations may include determining an emotional state of the animal using the behavioral, auditory, and physiological data input into a machine learning algorithm. The operations may include outputting the emotional state through a user interface. The operations may include continually adapting the machine learning algorithm through user feedback and new behavioral, auditory, and physiological data to improve determinations of emotional states of animals.

Some aspects described herein relate to a computer program product. The computer program product may include one or more computer-readable storage media and program instructions stored on the one or more computer-readable storage media to perform operations. The operations may include receiving, from a wearable device, physiological data of an animal, the physiological data including a heart rate, a body temperature, and movement. The operations may include collecting, by an environmental sensor, visual data, and auditory data of the animal, the visual data including images and videos, and the auditory data including sounds and vocalizations. The operations may include processing, by a machine learning model, the physiological data, the visual data, and the auditory data to generate insights into an emotional state and a need of the animal. The operations may include outputting, by a user interface, the insights and an indication of the need.

### BRIEF DESCRIPTION OF THE DRAWINGS

FIG. 1 is a diagram of an example computing environment for real-time interpretation of activity.

FIGS. 2A and 2B are diagrams of an example implementation associated with a system to monitor and analyze real-time activity.

FIG. 3 is a diagram of an example implementation of modules of a computer system associated with a system to monitor and analyze real-time activity.

FIG. 4 is a diagram illustrating an example of a data flow for real-time interpretation.

FIG. 5 is a diagram illustrating an example of artificial intelligence processing, in accordance with the present disclosure.

FIG. 6 is a diagram illustrating an example of querying.

FIG. 7 is a diagram illustrating an example of notifications to the user.

FIG. 8 is a diagram illustrating an example of user feedback.

FIG. 9 is a flowchart of an example process associated with real-time activity interpretation.

FIG. 10 is a flowchart of an example process associated with real-time animal behavior interpretation.

FIG. 11 is a flowchart of an example process associated with real-time animal behavior interpretation.

### DETAILED DESCRIPTION

The following detailed description of example implementations refers to the accompanying drawings. The same reference numbers in different drawings may identify the same or similar elements.

Sensors and wearable devices have become increasingly prevalent in monitoring various aspects of daily life, from tracking physical activity to measuring physiological parameters. These devices provide data, offering potential insights into patterns and behaviors. However, interpreting this data effectively remains a challenge. Despite the advanced capabilities of these devices, the translation of raw data into meaningful insights has not been as successful as anticipated. The complexity of the data often leads to oversimplified interpretations, limiting the potential benefits and applications of these technologies.

Some implementations described herein provide a method implemented by a computer system to monitor and analyze real-time activity of an object. For example, the computer system may receive, from a combination of a wearable device, a sensor, a camera, or a microphone, a multimodal data stream associated with the real-time activity, and may identify a pattern of the real-time activity based on the multimodal data stream. The computer system may convert the pattern into a natural language prompt, and may determine an interpretation of the real-time activity using the natural language prompt and a machine learning algorithm trained with a base dataset. The method may output an indication of the interpretation through a user interface of the computer system or connected to the computer system.

In this way, the computer system may conserve processing resources, memory resources, network resources, and/or the like. For example, the computer system may reduce the computational complexity of real-time activity analysis by utilizing a multimodal data stream and machine learning algorithm, as opposed to relying on manual observation or unimodal data analysis. Additionally, the computer system may reduce data transmission overhead by only transmitting relevant data patterns, rather than raw data, resulting in more efficient use of network resources.

An example of real-time activity may include the real-time activity of animate objects, such as the activity of animals. Animal communication has been a longstanding issue for humans. Despite centuries of coexistence, understanding the intricacies of an animal’s behavior and emotions can be an elusive goal. Humans have traditionally relied on observation and manual interpretation to grasp animal communications, from recognizing universal patterns like a wagging tail or a purring cat to deciphering subtle vocalizations. However, the complexity of these signals can lead to misunderstandings, neglect of emotional well-being, and straining the human-animal bond.

Conventional methods of understanding animal behavior have limitations. Behavioral training sessions and consultations with veterinarians or animal behaviorists provide generalized insights, but lack personalization and real-time monitoring. Technology-aided tools, such as basic wearable devices, focus on tracking physical activity or location, but fail to interpret nuanced behavioral and vocal cues.

Some implementations described herein provide a method implemented by a computer system to better understand animal behavior and emotions. For example, the computer system may receive, from a combination of a wearable device, a sensor, a camera, or a microphone, a multimodal data stream associated with real-time activity of an animal, and may identify a behavioral or physiological pattern of the animal based on the multimodal data stream. The computer system may convert the pattern into a natural language prompt, and may determine an interpretation of an emotional or physical state of the animal using the natural language prompt and a machine learning algorithm trained with a base dataset on animal behavior and physiology. The method may output an indication of the interpretation of the emotional or physical state of the animal through a user interface of the computer system or connected to the computer system. While the analysis by the computer system may be effective, the computer system can only provide an interpretation or estimate of an emotional state of an animal and does not purport to provide a definitive conclusion as to the emotional state of an animal.

By collecting data of real-time activity from multiple sources, determining a pattern from the data, converting the pattern to a natural language prompt that is entered into a machine learning algorithm, the computer system may receive a more accurate interpretation of animal activity. In this way, the computer system may conserve processing resources, memory resources, network resources, and/or the like. For example, the computer system may reduce the computational complexity of animal behavior analysis by utilizing a multimodal data stream and machine learning algorithm, as opposed to relying on manual observation or unimodal data analysis. Additionally, the computer system may reduce data transmission overhead by only transmitting relevant data patterns, rather than raw data, resulting in more efficient use of network resources. The computer system may also reduce the storage requirements for animal behavior data by compressing the data into natural language prompts, resulting in more efficient use of memory resources.

In some implementations, the wearable device may be configured to monitor physiological changes in the animal, and the machine learning algorithm may be trained to decipher behaviors, sounds, and physiological changes in real time. The computer system may train the machine learning algorithm using the multimodal data stream, and train the machine learning algorithm using user corrections or annotations to improve accuracy of the machine learning algorithm.

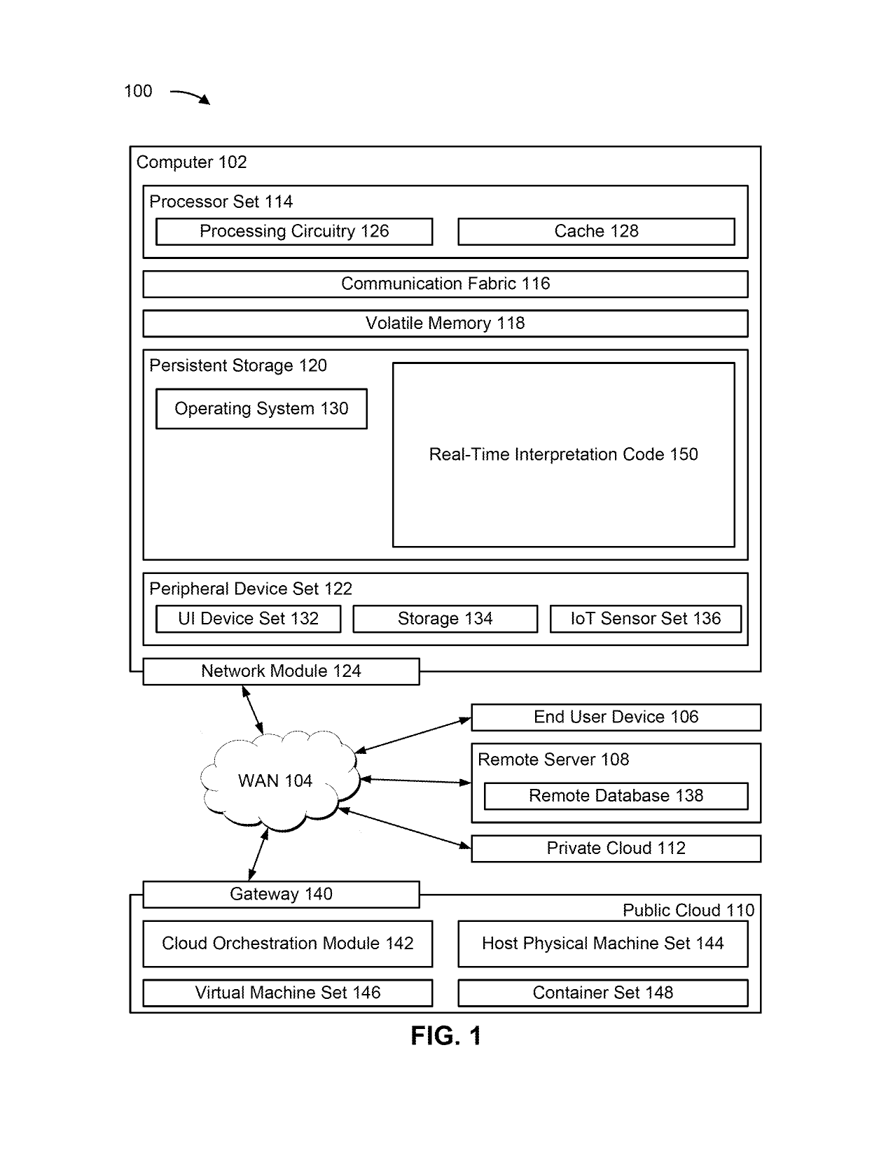

FIG. 1 is a diagram of an example computing environment 100 for real-time interpretation of activity.

The computing environment 100 contains an example of an environment for the execution of at least some of the computer code involved in performing the inventive methods, such as real-time interpretation code 150. In addition to the real-time interpretation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the real-time interpretation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 126 may be distributed over multiple packages, for example, multiple, coordinated integrated circuit chips. The processing circuitry 126 may implement multiple processor threads and/or multiple processor cores. The cache 128 is memory that is located in the processor chip package(s) and is typically used for data or code that should be available for rapid access by the threads or cores running on the processor set 114. Cache memories are typically organized into multiple levels depending upon relative proximity to the processing circuitry. Alternatively, some, or all, of the cache for the processor set may be located “off chip.” In some computing environments, the processor set 114 may be designed for working with qubits and performing quantum computing. Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in real-time interpretation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read only memory (ROM), but typically at least a portion of the persistent storage allows writing of data, deletion of data and re-writing of data. Some familiar forms of persistent storage include magnetic disks and solid state storage devices. The operating system 130 may take several forms, such as various known proprietary operating systems or open source Portable Operating System Interface-type operating systems that employ a kernel. The code included in the real-time interpretation code 150 typically includes at least some of the computer code involved in performing one or more operations described herein. The operations may include receiving, from at least two of a wearable device, a sensor, a camera, or a microphone, a multimodal data stream associated with real-time activity; identifying a pattern of the real-time activity based on the multimodal data stream; converting the pattern into a natural language prompt; determining an interpretation of the real-time activity using the natural language prompt and a machine learning algorithm; and outputting an indication of the interpretation through a user interface.

In some implementations involving a use case with animal activity, the operations may include, for example, receiving, from at least two of a wearable device, a sensor, a camera, or a microphone, a multimodal data stream associated with real-time activity of an animal; identifying a behavioral or physiological pattern of the animal based on the multimodal data stream; converting the pattern into a natural language prompt; determining an emotional or physical state of the animal using the natural language prompt and a machine learning algorithm trained with a base dataset on animal behavior and physiology; and outputting an indication of the emotional or physical state of the animal through a user interface.

In some implementations, the operations may include receiving behavioral, auditory, and physiological data of an animal, from a wearable device, a camera, and a microphone; determining an emotional state of the animal using the behavioral, auditory, and physiological data input into a machine learning algorithm; outputting the emotional state through a user interface; and continually adapting the machine learning algorithm through user feedback and new behavioral, auditory, and physiological data to improve determinations of emotional states of animals.

In some implementations, the operations may include receiving, from a wearable device, physiological data of an animal, the physiological data including a heart rate, a body temperature, and movement; collecting visual data, and auditory data of the animal, the visual data including images and videos, and the auditory data including sounds and vocalizations; processing the physiological data, the visual data, and the auditory data to generate insights into an emotional state and a need of the animal; and outputting the insights and an indication of the need.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

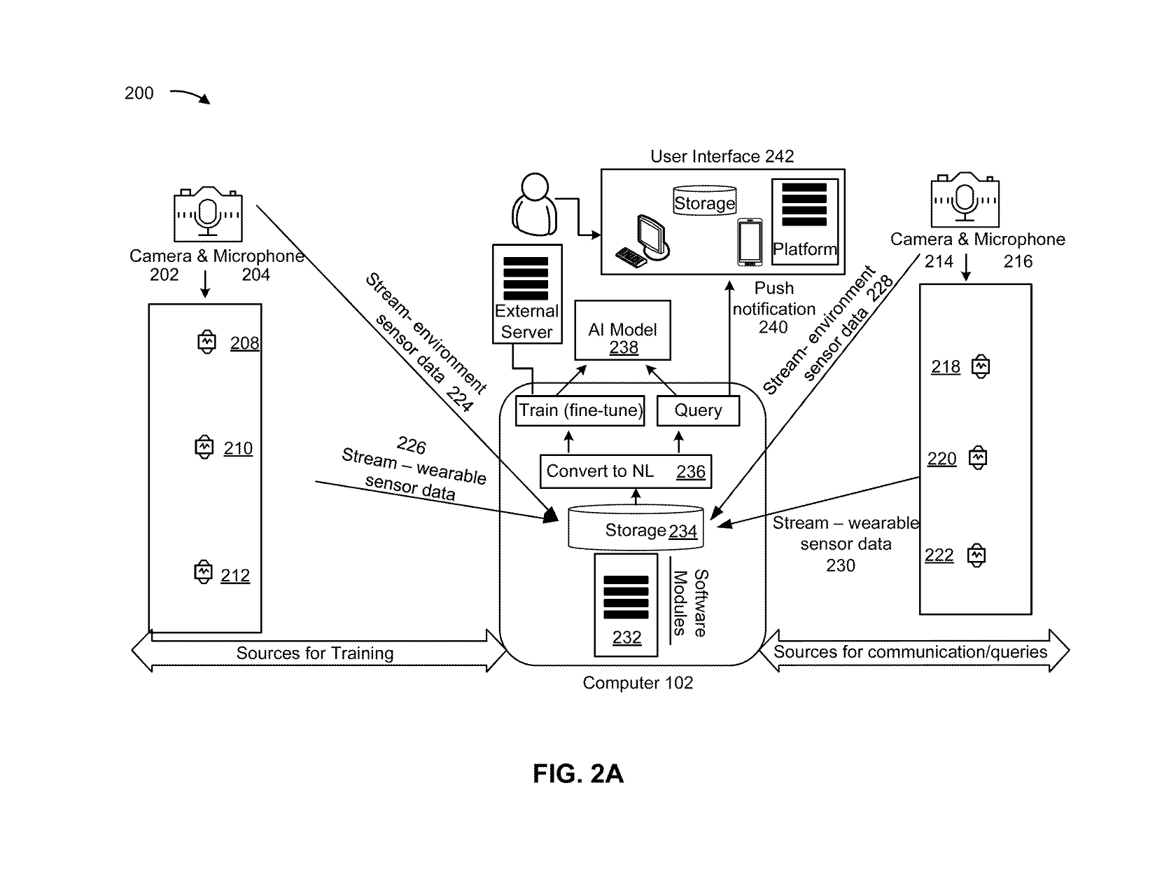

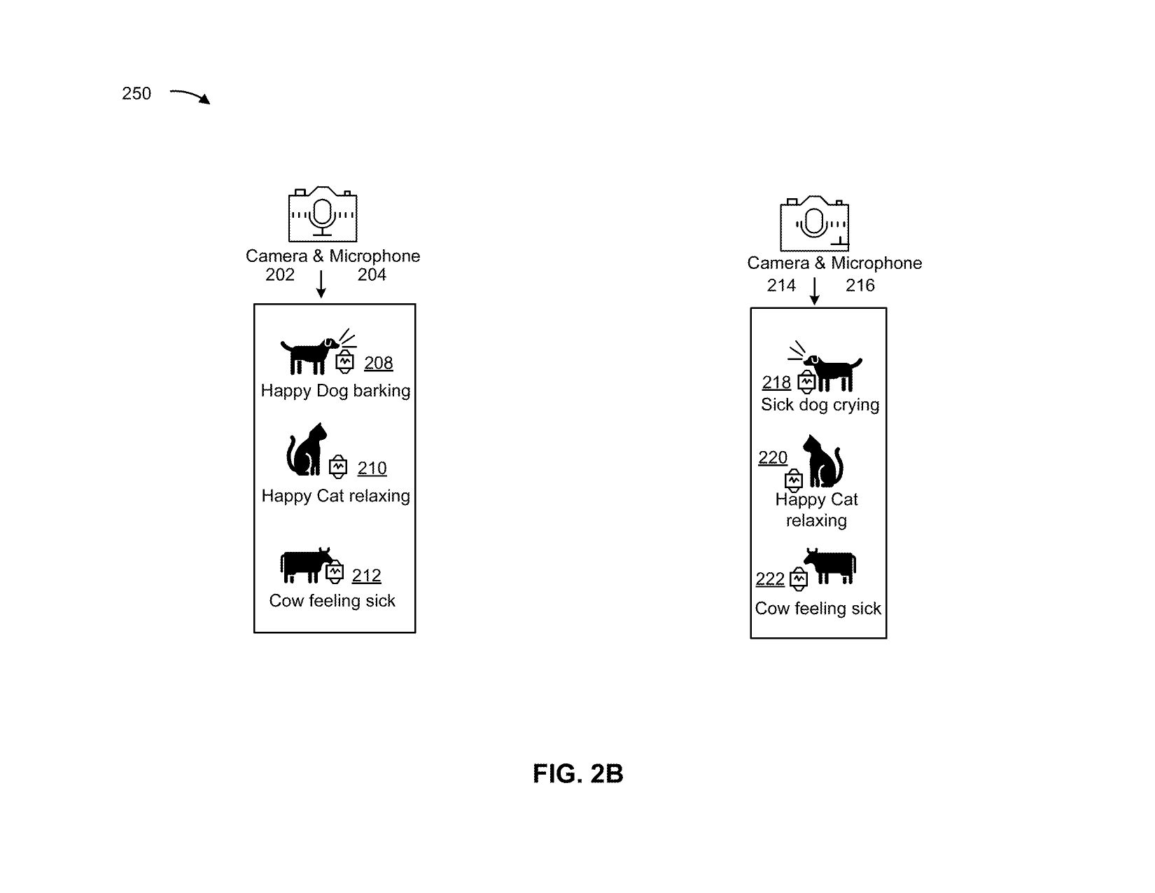

FIG. 2A is a diagram of an example implementation 200 associated with a computer system to monitor and analyze real-time activity of an object. The example implementation 200 includes a computer system (e.g., computer 102) that is configured to execute a computer-implemented method of providing a real-time interpretation of the real-time activity of animate or inanimate objects.

A real-time interpretation of data patterns of the real-time activity involves the immediate analysis and translation of data collected from multiple sensors, cameras, microphones, or wearable devices into meaningful insights about the real-time activity. This process employs advanced algorithms and machine learning models to detect patterns and correlations in the data from a combination of sources, enabling quick and accurate understanding of the real-time activity as the activity occurs.

The computer system may receive a multi-modal data stream from one or more data sources. FIG. 2A shows two data sources. A first data source provides environment sensor data 224 collected from a camera 202 and a microphone 204. The first data source also provides wearable sensor data 226 from a wearable sensor, such as shown by wearable sensors 208, 210, and 212. These data sources may be used for training. A second data source provides environment sensor date 228 collected from a camera 214 and a microphone 216. The second data source also provides wearable sensor data 230 from a wearable sensor, such as shown by wearable sensors 218, 220, and 222. These data sources may be used for communication and queries.

The computer system may include software modules 232 that execute code stored in storage 234. The storage 234 may collect and store the data from the data sources. The computer system may use an NL module 236 to convert the data to a natural language prompt that is used as a query to a machine learning (ML) algorithm that uses an NL model (e.g., artificial intelligence (AI) model 238). The NL module may also use data and NL prompts to train and fine-tune the AI model 238. The computer system may also provide push notifications 240 to a user device with a user interface 242, which may be configured for streaming or notifications.

In some implementations, the processing of real-time activity data may include converting binary data generated by the environmental sensor into a readable format. For example, the computer system may use a hexadecimal editor, a protocol analyzer, or a custom parsing script to decode the binary data into a format that can be analyzed by the machine learning algorithm.

In a use case, the real-time activity may include real-time activity of an animate object such as an animal, and the computer system may monitor and analyze an animal behavior or physiology. For example, if a wearable device on a dog that monitors heart rate, temperature, and movement detects an elevated heart rate and increased pacing, the computer system may determine that the dog is experiencing anxiety or excitement. This insight can be promptly communicated to the dog owner through a mobile application, allowing them to take immediate action, such as calming the dog or removing the dog from a stressful environment. In another example, if cameras and microphones in a cat's living area captures frequent meowing and restless movement, the computer system may interpret these signals as signs of distress or hunger. The computer system can then alert the owner, suggesting that the cat may need attention or feeding, thereby improving the cat’s care and well-being.

FIG. 2B shows devices in example implementation 250 that may collect data for the use case, including for interpreting animal behavior or physiology. The devices may include wearable sensors 208 (dog barking), 210 (cat relaxing), and 212 (sick cow). Other devices may include wearable sensors 218 (sick dog crying), 220 (happy cat relaxing), and 222 (sick cow). A real-time interpretation of data patterns for animal behavior may involve the immediate analysis and translation of data collected from sensors, cameras, microphones, or wearable devices into meaningful insights about an animal's actions, emotions, or physiological states. This process employs advanced algorithms and machine learning models to detect patterns and correlations in the data, enabling quick and accurate understanding of an animal's behavior as the behavior occurs.

The computer system may determine and provide textual output as part of a simple, timely, transparent, online or one-click wireless approach to monitor animals and provide animal care in a more timely fashion. In some implementations, the computer system may auto-save short video clips of specific behavior of interest or concern. For example, the computer system may use computer vision algorithms to detect abnormal behavior, such as limping or lethargy, and save short video clips of these events for later review by a veterinarian or animal care professional.

The computer system may receive user input for customizable notification preferences. For example, the computer system may allow users to set up custom notification rules based on specific behavioral or physiological patterns, such as sending a notification when the animal's heart rate exceeds a certain threshold.

Additionally, or alternatively, the system may implement a feedback mechanism that enables a user to validate or correct interpretations of the emotional state. For example, the computer system may allow users to provide feedback on the accuracy of the emotional state interpretations, which can be used to refine the ML algorithm and improve its accuracy over time.

ML models may incorporate weather patterns and community-shared insights. For example, the system may use data from weather APIs to incorporate weather patterns into the ML models, which can help to improve the accuracy of the emotional state determinations.

The computer system may continually adapt the ML algorithm through user feedback and new behavioral, auditory, and physiological data. For example, the system may use online learning techniques to update the ML algorithm in real-time based on new data and user feedback, which can help to improve the accuracy and effectiveness of the system over time.

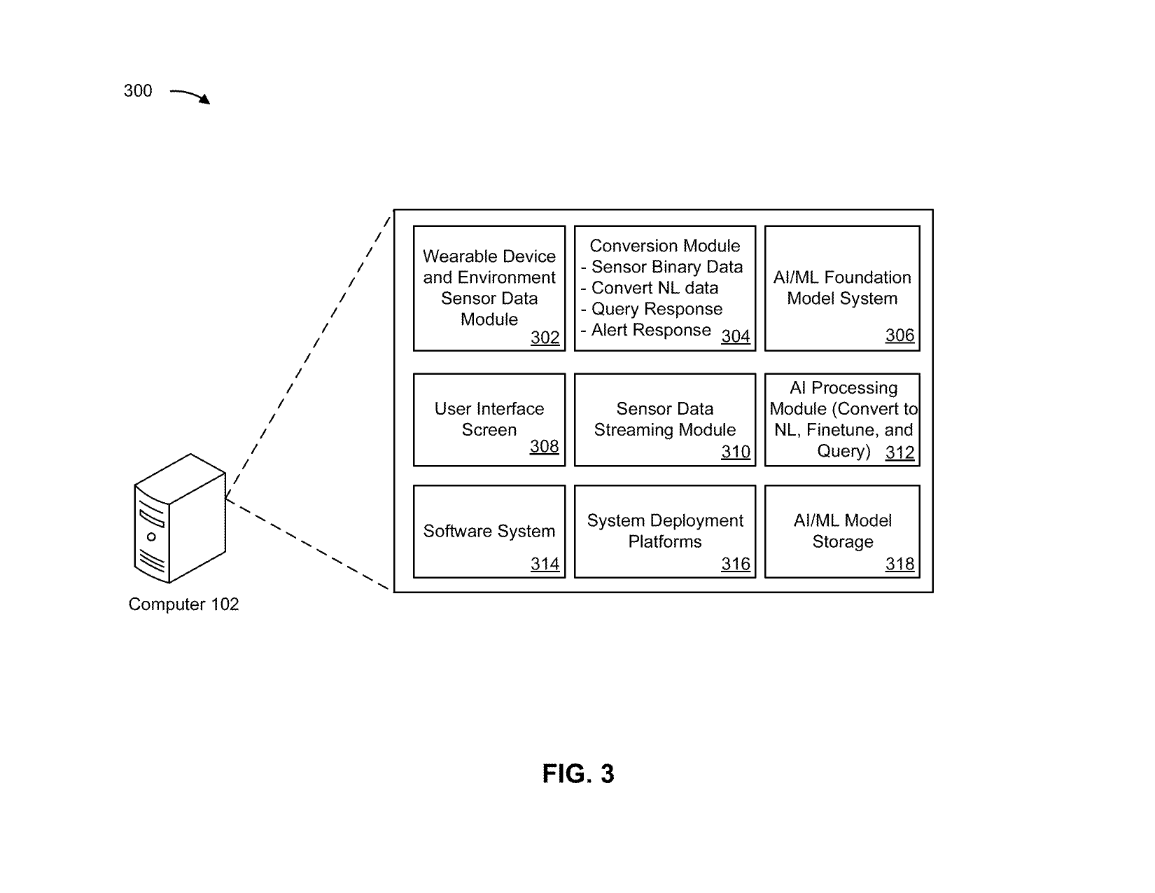

FIG. 3 is a diagram of an example implementation 300 of modules of a computer system (e.g., computer 102) associated with a system to monitor and analyze real-time activity, such as the behavior and physiological state of animals.

The computer system may include a wearable device and environmental sensor data module 302 to receive and process sensor data received from sensors in proximity to the animal and other devices. A sensor data streaming module 310 may control the reception of the sensor data. A conversion module 304 may convert the raw sensor data (e.g., binary data) into a pattern and use the pattern to generate NL data (prompts) for an ML algorithm. The ML algorithm may then provide a query response or an alert response. The ML algorithm may use a model that is part of an AI/ML foundation model system 306 and that uses an AI processing module 312. The ML algorithm and associated models may be stored in an AI/ML model storage 318.

The computer system may provide output to and receive input from a user interface screen 308. The user interface screen 308 is an intermediary between the computer system’s interpretation of animal behavior and physiology and feedback from a user of the computer system. The user interface screen 308 receives user input and provides information to the user, ensuring the system remains adaptive and insightful. The user interface screen 308 may be part of a mobile application or a web portal that provides timely notifications based on the interpretations.

The AI processing module 312 may use the data, prompts, responses, and user input to fine-tune or train the ML algorithm. The computer system may include a software system 314 that provides additional functionality for processing the data and providing output (e.g., text to the user interface screen 308). The computer system may include system deployment platforms 316 for implementing the monitoring and processing.

Referring to the animal behavior use-case, before setting up any equipment, the user may be prompted, via the user interface screen 308, to conduct a quick survey of their living space to identify key areas where the animal spends most of its time, such as a favorite couch, bed, or play area. The computer system may ask questions such as "Where does your pet usually eat?" or "Where do they often nap?" to ascertain important locations. Based on the environmental situation, the user is guided on placing cameras for optimal visual coverage. Wide-angle lenses might be suggested for larger spaces, while more focused cameras could be used for specific spots like feeding areas. Recognizing user concerns about privacy, the cameras and sensors may be set to only monitor during specific times or can have areas of exclusion where cameras will not record.

Data captured by camera and microphone mainly constitutes behavior analysis. Using advanced image processing algorithms, the computer system identifies and logs specific behaviors. For example, a cat's arched back indicates a defensive posture, or a dog's raised hackles may signal alertness. Cameras are equipped to detect subtle facial expressions, such as a rabbit's nose twitching or the dilation of a cat's pupils. The computer system has an ability to amalgamate diverse data sources for a holistic understanding of the animal’s state. By drawing from physiological, visual, and auditory data streams, the computer system generates a multi-faceted profile of the animal's experiences, behaviors, and emotions at any given moment.

The wearable device remains active as long as the wearable device is attached to the animal, ensuring round-the-clock collection of vital metrics. Depending on the animal's activity level, the wearable device may adjust its data sampling rate. For example, during intense physical activity, heart rate data might be captured more frequently to give a clearer picture. Beyond just heart rate and temperature, the wearable device may also detect more nuanced indicators like muscle tension or dermal activity, providing insights into stress or excitement levels. Using advanced image processing algorithms, the computer system may identify and logs specific behaviors. For example, a cat's arched back indicates a defensive posture, or a dog's raised hackles may signal alertness. Emotions are not just displayed through body language. The cameras are equipped to detect subtle facial expressions, like a rabbit's nose twitching or the dilation of a cat's pupils.

Whether it's a dog's bark, a cat's purr, or a bird's song, the computer system may employ machine learning to decipher and categorize these vocal cues into an interpretation that is understandable feedback for the owner. Not all sounds in the environment are considered background noise. The computer system may be trained to highlight sounds that may have a direct impact on the animal's well-being, such as the rumble of thunder or the ring of a doorbell.

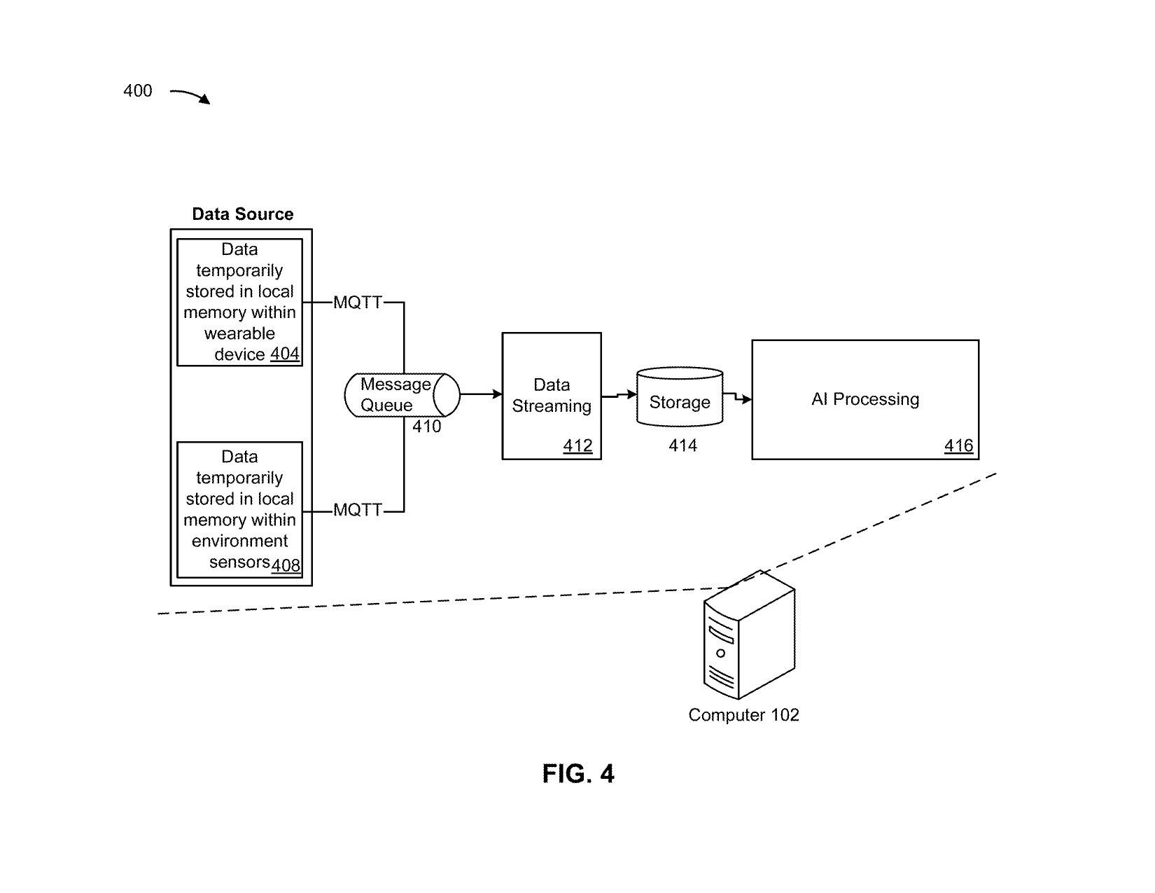

FIG. 4 is a diagram illustrating an example 400 of a data flow for real-time interpretation.

Using IoT protocols like message queuing telemetry transport (MQTT) or constrained application protocol (CoAP) for efficient and secure data transmission, the computer system ensures seamless device-cloud communication. This may include receiving wearable data 404 stored in local memory (e.g., local memory within a wearable device) and environmental data 408 stored in local memory (e.g., local memory within one or more environment sensors). This data is transmitted to a message queue 410 using a protocol such as MQTT. Data streaming 412 may provide the data to storage 414 and on to AI processing 416. For user-system communication, standard hypertext transfer protocol secure (HTTPS) protocols and WebSockets tools are utilized for real-time data exchange between users and the system. Data streaming allows for continuous transfer of data at a steady, high speed for processing.

The computer system employs a comprehensive approach to data aggregation and storage, ensuring that every piece of data, whether physiological, visual, or auditory, is constantly streamed to its central processing unit. In this centralized hub, data is not merely stored but actively compared, contrasted, and analyzed in real-time to provide valuable insights. Temporary local storage is utilized on the wearable or environment sensors before data is transmitted to ensure seamless data flow. For long-term storage, cloud solutions are employed to securely store the collected data in centralized databases.

In an example, a sensor is wired or wirelessly coupled to digital devices using single-board microcontrollers and microcontroller kits, establishing a connection for data transmission. The digital devices then read the potentiometer sensor value, storing the sensor value in local memory. The sensor value is subsequently transmitted over a serial line or a wireless link as a byte string. The data is read from the serial line or wireless link and pushed as a byte string using MQTT to a message queue 410. Finally, the data is streamed from the message queue to storage 414, where the data is prepared for the AI processing 416, enabling advanced analysis and insights.

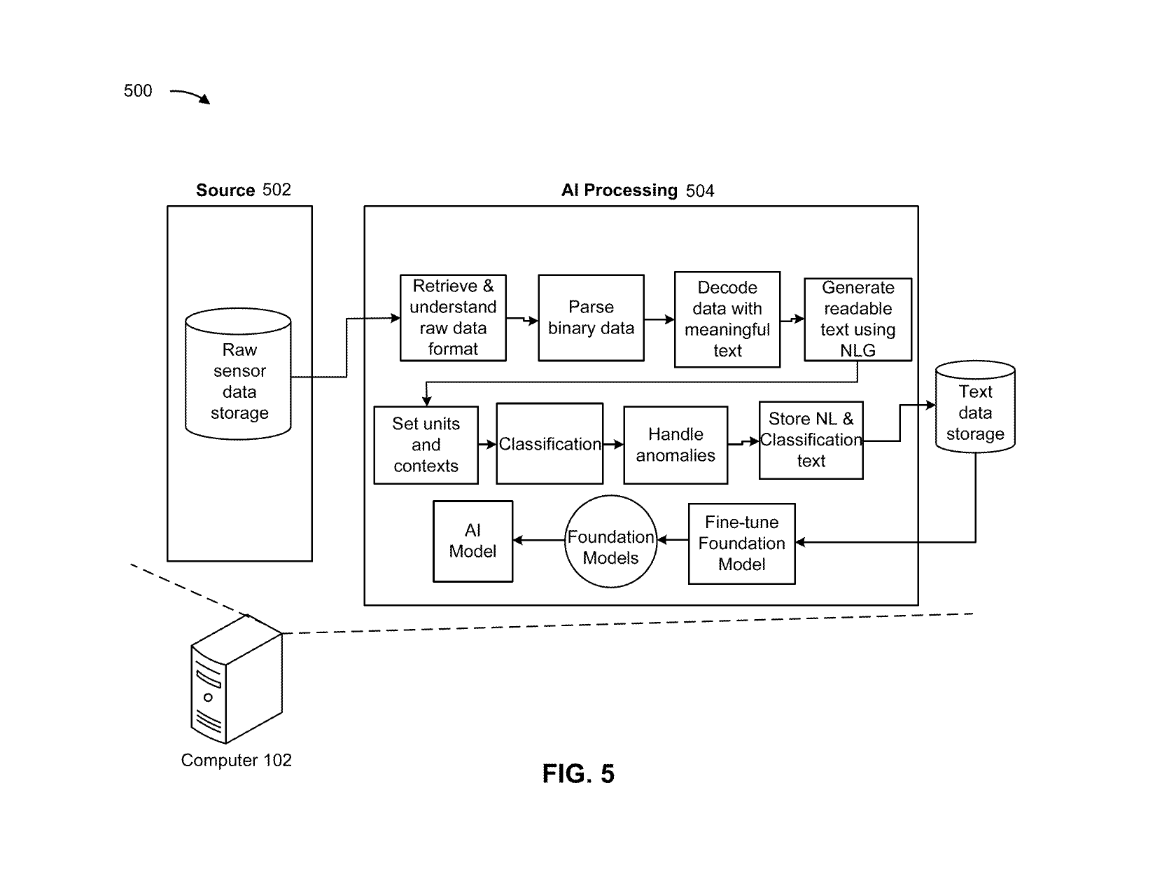

FIG. 5 is a diagram illustrating an example 500 of AI processing, in accordance with the present disclosure. Example 500 shows a data source 502 that includes raw sensor data storage. Example 500 also show AI processing 504 that uses an ML model (AI model) for an animal of the user, and this AI model is based on an AI foundation model that is trained with datasets of animal activity for multiple animals. The AI processing 504 may incorporate a feedback loop mechanism that integrates user feedback to retrain the AI model and to retrain the AI foundation model.

The AI processing 504 shows a flowchart associated with understanding a data structure and data format (e.g., for binary data from a sensor) and using or training the AI model. The computer system may analyze the sensor data (e.g., binary, hexadecimal, and character representation) and identify patterns, headers, and potentially recognizable values. The computer system may determine repeating patterns, known markers, or fixed-length fields that can indicate the data structure.

The computer system may parse the sensor data and decode the data with meaningful text. Format strings may be defined to specify how binary data is structured (data types, endianness, alignment). The computer system may use natural language generation (NLG) techniques to generate human-readable text. NLG involves converting structured data into text that sounds natural, using templates, rules, or advanced techniques like NL ML models. The computer system may set units and context to provide a clear understanding of the data. For example, for the animal use case, "barking frequency is 200Hz" is more informative than "audio signals is 200."

Once NLG is completed, the computer system may classify animal signals captured in NL. The computer system may also handling anomalies and consider scenarios where binary data might be corrupted or incomplete. Error-checking mechanisms may handle such situations gracefully, generating appropriate error messages or alerts in the NL text. The computer system may store the final classification and NL text in a large storage location. The computer system may fine-tune the AI foundational model with the stored NL data or the AI model used for the specific animal being observed.

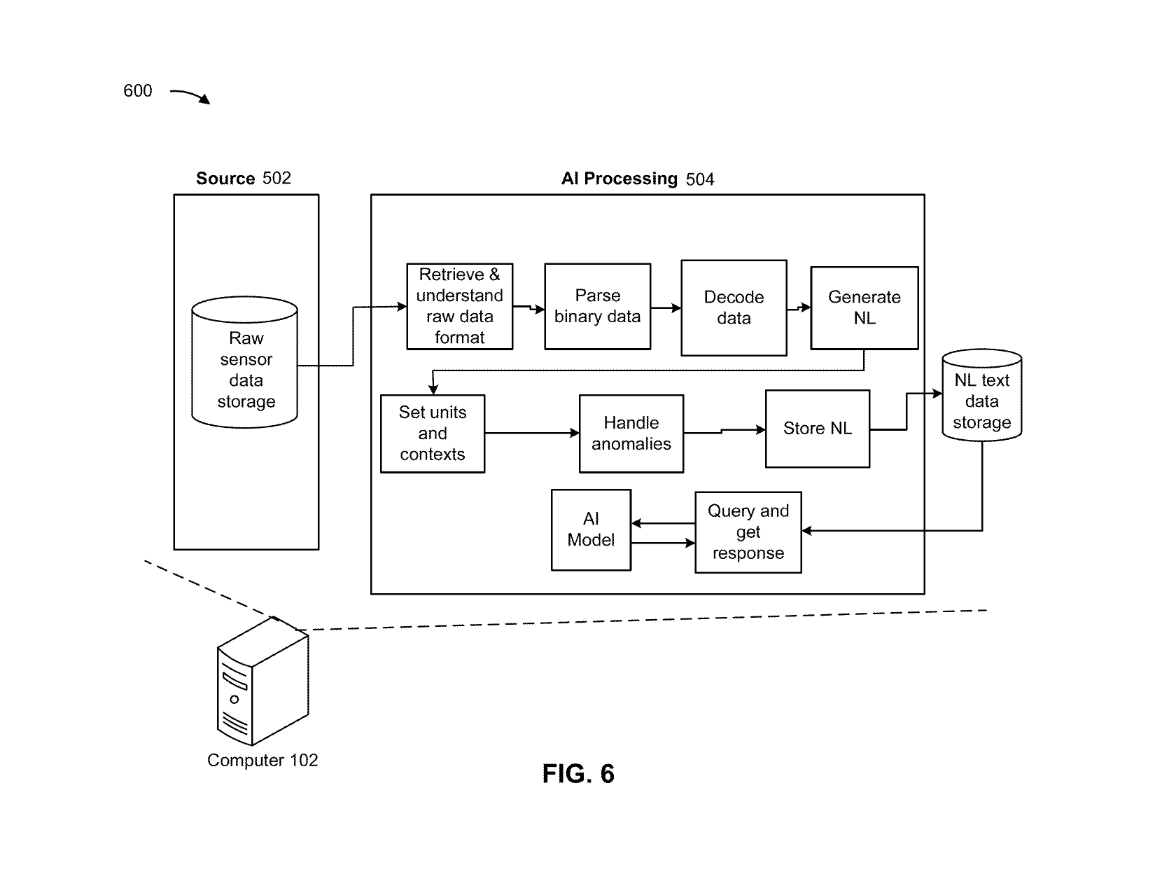

FIG. 6 is a diagram illustrating an example 600 of querying. Example 600 shows the computer system using the stored NL text data to query the AI model to obtain a response that is an interpretation of real-time activity, such as an interpretation of animal behavior or physiology. There may be multiple queries based on the stored NL text data. This may result in multiple responses that are analyzed or synthesized for presentation to the user through the user interface.

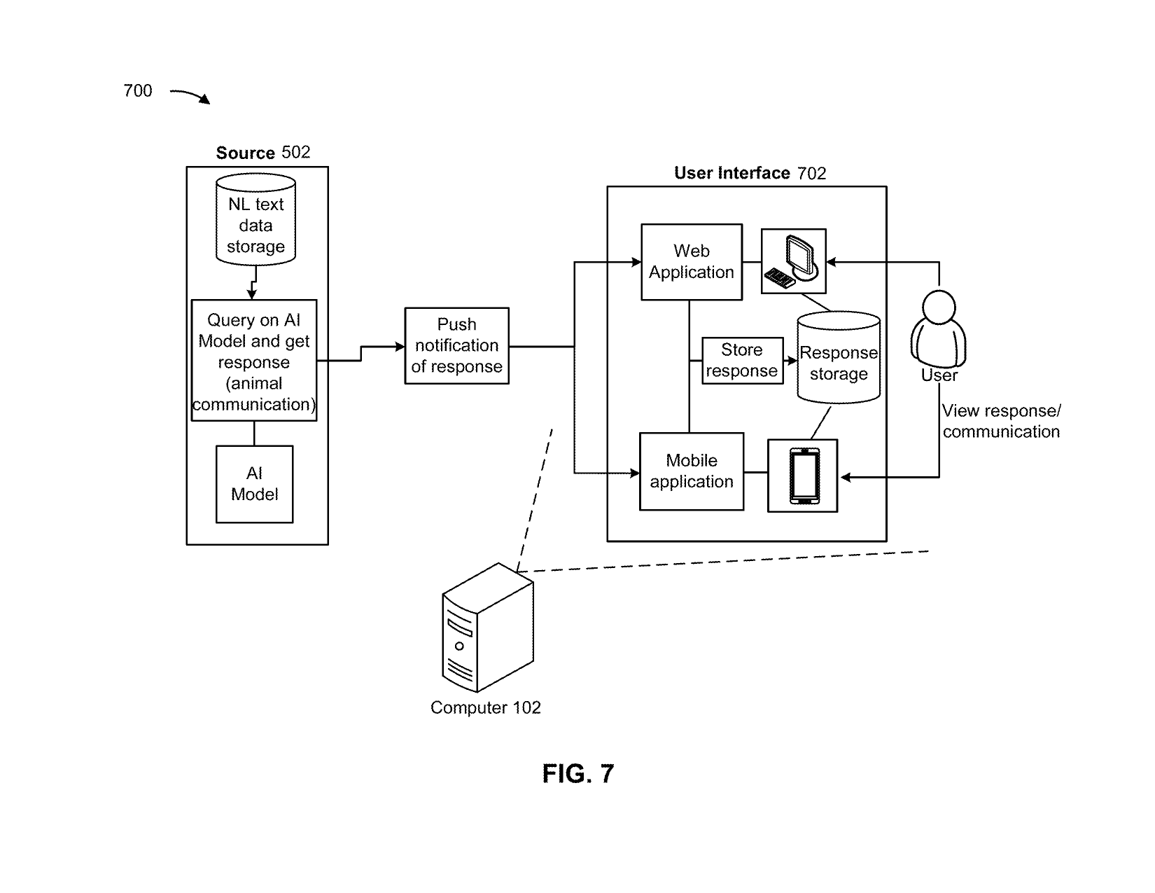

FIG. 7 is a diagram illustrating an example 700 of notifications to the user. The computer system may provide real-time alerts and push notifications to the user via the user interface. Components of the user interface are shown in user interface 702. The user may expand on each notification to obtain more detailed insights or view relevant footage/recordings. Through the user interface 702, the user may, for example, explore behavioral and health trends over time. Charts, graphs, and heatmaps provide a comprehensive view of the animal's patterns and changes.

In some implementations, for every major insight, users can validate or refute the interpretation provided by the computer system. An "Agree/Disagree" button in the user interface 702 could serve this purpose, capturing user feedback instantaneously. Users can add notes or annotations for specific events or behaviors. This provides contextual information that can refine AI interpretations. For example, marking “fireworks outside" can help the system understand heightened stress levels in animals.

Based on the interpretation, the computer system may offer suggestions through the user interface 702. For example, if the computer system detects an animal's anxiety, the computer system may suggest: "Your dog appears anxious. Consider taking them for a walk or offering a chew toy." Apart from immediate suggestions, the computer system may also offer broader advice based on accumulated data, like changes in diet, exercise patterns, or potential vet consultations. In some implementations, users can manage and update an animal’s profile, incorporating any changes in diet, health conditions. The user can add new animals. The computer system allows users to customize notification settings, data sharing options, and more, ensuring a tailored user experience.

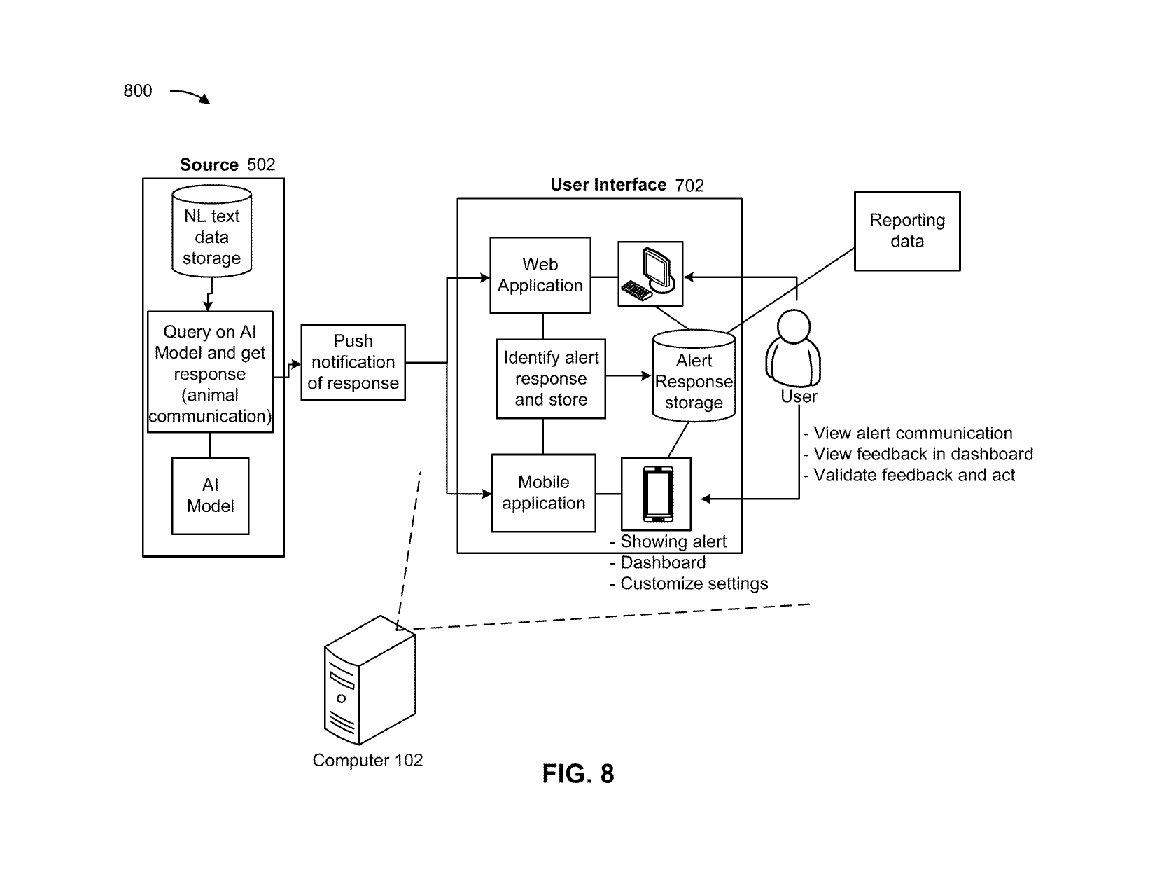

FIG. 8 is a diagram illustrating an example 800 of user feedback. Example 800 shows the process of feedback generation within the computer system. For example, through real-time alerts and comprehensive reports, the computer system ensures that caregivers are always attuned to the animal's well-being, enabling them to respond effectively to the animal's needs.

The feedback generation process begins with immediate notifications, which are important for situations demanding urgent attention. Real-time alerts are pushed out when an animal displays signs of extreme stress or discomfort, ensuring caregivers can respond promptly to emergent situations. To prevent overwhelming users, notification preferences can be customized, allowing caregivers to receive only the most pertinent alerts in line with customized settings.

Detailed reporting is another aspect of the computer system's feedback process. Periodic summaries provide insights into broader trends, such as, "Your dog has been notably more active in the evenings." These reports can be scheduled according to user preference, whether daily, weekly, or monthly. Additionally, the computer system maintains a log of historical data, which aids in tracking changes over time and can be invaluable during veterinary consultations.

Visual feedback is provided through interactive dashboards available on the computer system's user interface 702. Users can delve deeper into the data with interactive charts, heatmaps, and timelines that illustrate behaviors, activity levels, and notable events. For specific behaviors of interest or concern, the computer system may auto-save short video clips, allowing caregivers to visually verify certain activities or behaviors.

Feedback validation is a feature that allows caregivers to refine the system's interpretations. Through the user interface 702, caregivers can confirm or correct the AI's interpretation, such as if the computer system suggests, "Your cat seems playful," but the user observes aggression. This feedback helps refine future interpretations. Furthermore, with user consent, specific data or insights can be shared with a community of users, fostering community-driven knowledge sharing that assists in refining interpretations and gaining broader insights.

Real-time interpretations and feedback significantly enhance the computer system by providing immediate, actionable insights that improve both user experience and system accuracy. By allowing the system to instantly analyze data and detect unusual patterns or behaviors, caregivers receive timely alerts about the animal's well-being, enabling prompt responses to urgent situations such as signs of stress or discomfort. The customization of notification settings ensures that caregivers receive only the most relevant alerts, reducing information overload and conserving processing resources by focusing computational efforts on critical events.

Continuous learning and adaptation are facilitated through real-time feedback from users, allowing the system to refine its algorithms and improve accuracy over time. This dynamic feedback loop not only enhances system reliability but also optimizes processing resources of the computer system by prioritizing the processing of validated and corrected interpretations. Enhanced user engagement is achieved through interactive dashboards and visual feedback, such as charts and video clips, which allow users to intuitively explore data and gain a deeper understanding of the animal's behavior and health.

Community insights, shared with user consent, contribute to refining interpretations and provide broader insights, benefiting all users and further conserving resources by leveraging collective knowledge. The proactive care enabled by real-time feedback empowers caregivers to manage their pet's health more effectively, leading to early intervention and better long-term outcomes. Overall, the feedback features of the computer system not only transform it into a responsive tool that meets immediate caregiver needs but also ensure efficient resource utilization by focusing processing power on the most pertinent and validated data.

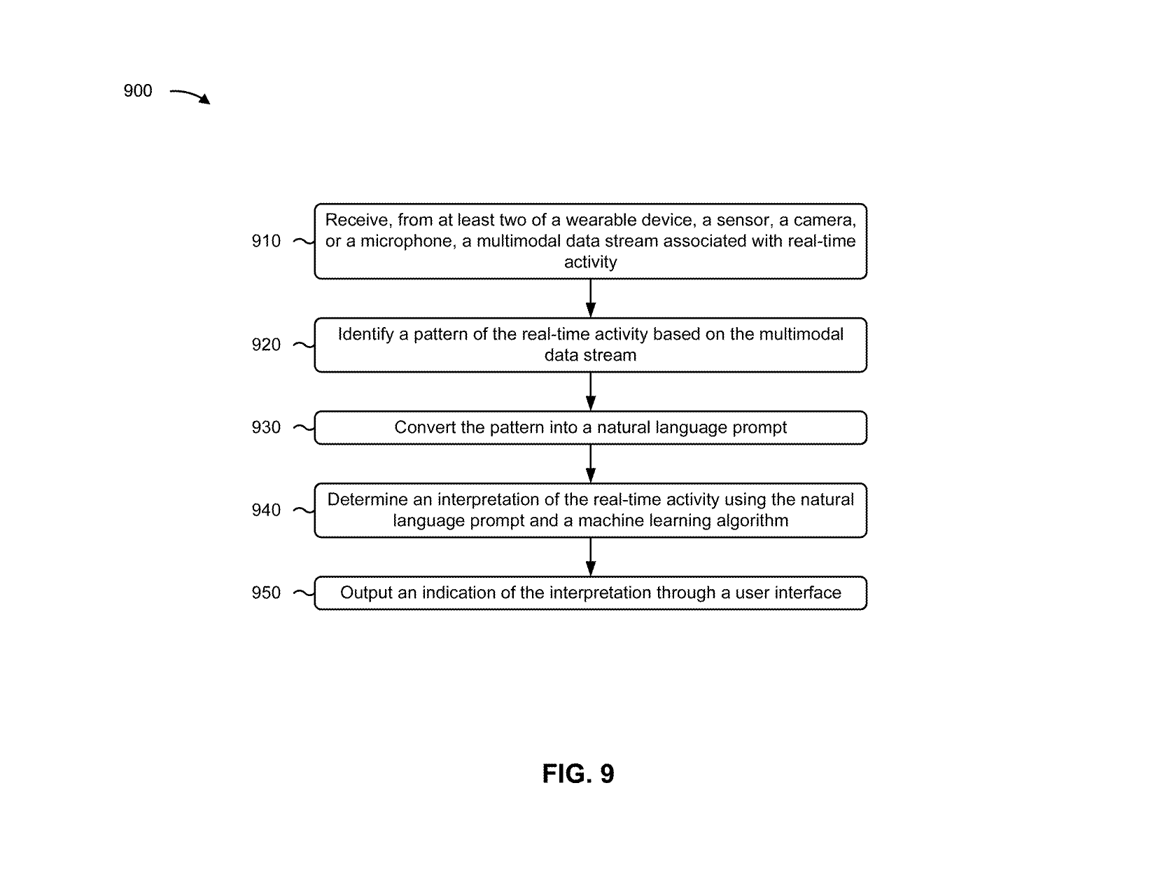

FIG. 9 is a flowchart of an example process 900 associated with real-time activity interpretation. One or more process blocks of FIG. 9 are performed by a computer system (e.g., computer 102) and/or by another device or a group of devices separate from or including the computer system.

As shown in FIG. 9, process 900 includes receiving, from at least two of a wearable device, a sensor, a camera, or a microphone, a multimodal data stream associated with real-time activity (block 910). For example, the computer system may receive, from at least two of a wearable device, a sensor, a camera, or a microphone, a multimodal data stream associated with real-time activity, as described above.

As further shown in FIG. 9, process 900 includes identifying a pattern of the real-time activity based on the multimodal data stream (block 920). For example, the computer system may identify a pattern of the real-time activity based on the multimodal data stream, as described above.

As further shown in FIG. 9, process 900 includes converting the pattern into an NL prompt (block 930). For example, the computer system may convert the pattern into a NL prompt, as described above.

As further shown in FIG. 9, process 900 includes determining an interpretation of the real-time activity using the NL prompt and an ML algorithm (block 940). For example, the computer system may determine an interpretation of the real-time activity using the NL prompt and an ML algorithm, as described above.

As further shown in FIG. 9, process 900 includes outputting an indication of the interpretation through a user interface (block 950). For example, the computer system may output an indication of the interpretation through a user interface, as described above.

Process 900 may include additional aspects, such as any single aspect or any combination of aspects described below and/or in connection with one or more other processes described elsewhere herein.

In a first aspect, process 900 includes training the ML algorithm further using the multimodal data stream.

In a second aspect, alone or in combination with the first aspect, process 900 includes training the ML algorithm using the multimodal data stream and user corrections or annotations to improve accuracy of the ML algorithm.

In a third aspect, alone or in combination with one or more of the first and second aspects, the real-time activity includes real-time activity of an animal, and the identifying the pattern includes identifying a behavioral or physiological pattern of the animal based on the multimodal data stream.

In a fourth aspect, alone or in combination with one or more of the first through third aspects, the interpretation includes an interpretation of an emotional or physical state of the animal, and the ML algorithm is trained with a base dataset on animal behavior and physiology.

In a fifth aspect, alone or in combination with one or more of the first through fourth aspects, process 900 includes transmitting, to a centralized database, a log of historical data associated with behavioral or physiological patterns of animals, associated NL prompts, and corresponding emotional or physical states, and receiving, from the centralized database, information associated with long-term trends.

In a sixth aspect, alone or in combination with one or more of the first through fifth aspects, the ML algorithm is trained using a combination of audio, visual, and physiological data from multiple sources.

In a seventh aspect, alone or in combination with one or more of the first through sixth aspects, the determining includes recognizing patterns and correlations between different types of real-time activity data.

In an eighth aspect, alone or in combination with one or more of the first through seventh aspects, process 900 includes receiving feedback or recommendations that are personalized based on preferences and interaction patterns of a user.

In a ninth aspect, alone or in combination with one or more of the first through eighth aspects, process 900 includes communicating information about insights and experiences with other devices.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

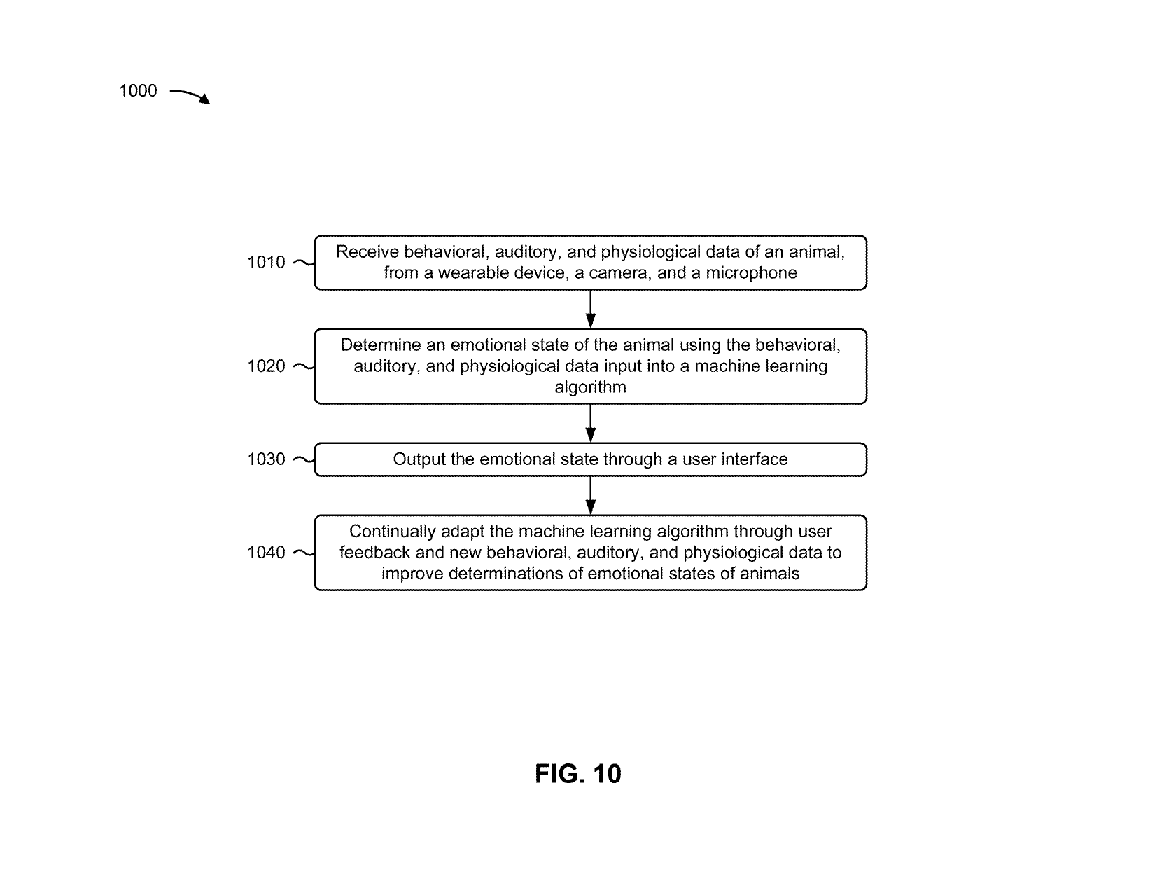

FIG. 10 is a flowchart of an example process 1000 associated with real-time animal behavior interpretation. One or more process blocks of FIG. 10 are performed by a computer system (e.g., computer 102) and/or by another device or a group of devices separate from or including the computer system.

As shown in FIG. 10, process 1000 includes receiving behavioral, auditory, and physiological data of an animal, from a wearable device, a camera, and a microphone (block 1010). For example, the computer system may receive behavioral, auditory, and physiological data of an animal, from a wearable device, a camera, and a microphone, as described above.

As further shown in FIG. 10, process 1000 includes determining an emotional state of the animal using the behavioral, auditory, and physiological data input into an ML algorithm (block 1020). For example, the computer system may determine an emotional state of the animal using the behavioral, auditory, and physiological data input into an ML algorithm, as described above.

As further shown in FIG. 10, process 1000 includes outputting the emotional state through a user interface (block 1030). For example, the computer system may output the emotional state through a user interface, as described above.

As further shown in FIG. 10, process 1000 includes continually adapting the ML algorithm through user feedback and new behavioral, auditory, and physiological data to improve determinations of emotional states of animals (block 1040). For example, the computer system may continually adapt the ML algorithm through user feedback and new behavioral, auditory, and physiological data to improve determinations of emotional states of animals, as described above.

Process 1000 may include additional aspects, such as any single aspect or any combination of aspects described below and/or in connection with one or more other processes described elsewhere herein.

In a first aspect, the wearable device includes one or more sensors to track real-time physiological changes in the animal, including heart rate variability and skin responses.

In a second aspect, alone or in combination with the first aspect, the user interface is associated with a mobile application that displays the emotional state of the animal, offers notifications, and allows a user to provide feedback for the ML algorithm.

In a third aspect, alone or in combination with one or more of the first and second aspects, the ML algorithm includes machine learning models that incorporate weather patterns and community-shared insights.

In a fourth aspect, alone or in combination with one or more of the first through third aspects, process 1000 includes a feedback mechanism that enables a user to validate or correct determinations of the emotional state.

Although FIG. 10 shows example blocks of process 1000, in some implementations, process 1000 includes additional blocks, fewer blocks, different blocks, or differently arranged blocks than those depicted in FIG. 10. Additionally, or alternatively, two or more of the blocks of process 1000 may be performed in parallel.

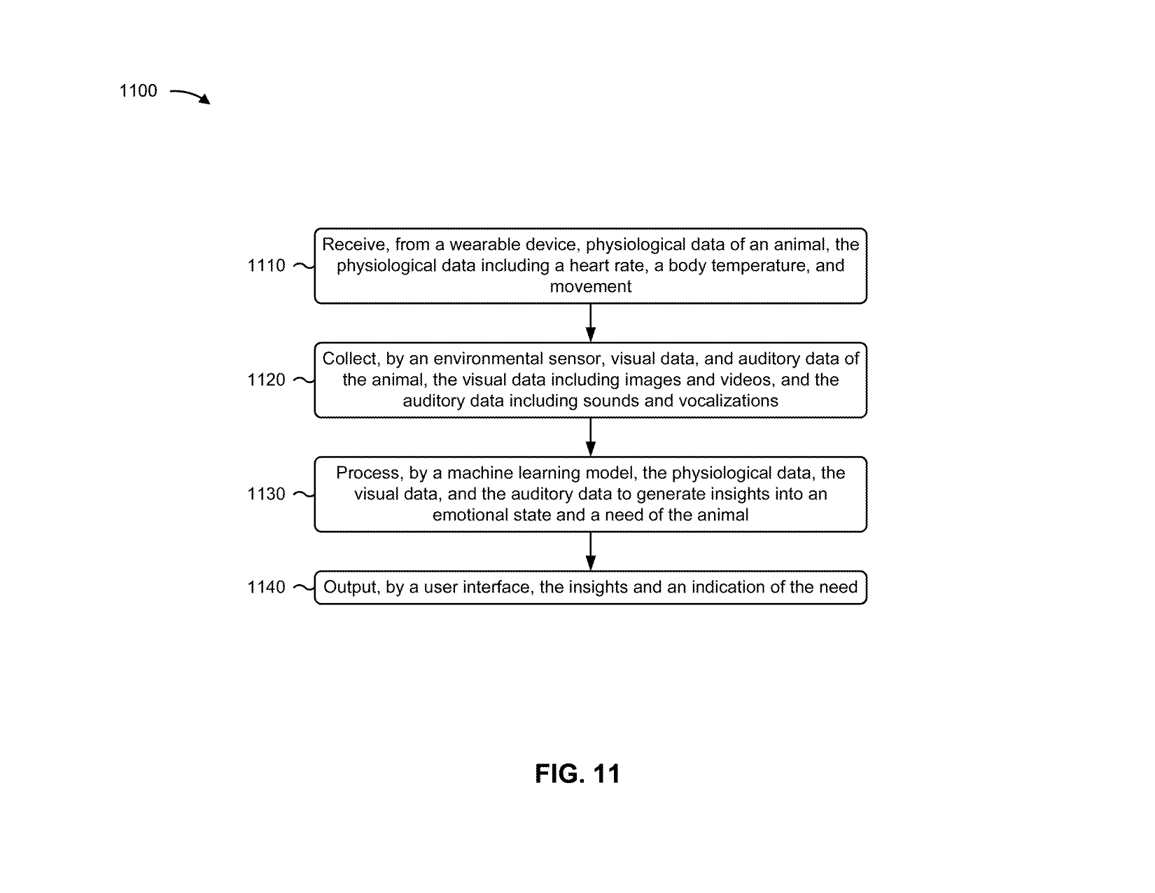

FIG. 11 is a flowchart of an example process 1100 associated with real-time animal behavior interpretation. One or more process blocks of FIG. 11 are performed by computer system (e.g., computer 102) and/or by another device or a group of devices separate from or including the computer system.

As shown in FIG. 11, process 1100 includes receiving, from a wearable device, physiological data of an animal, the physiological data including a heart rate, a body temperature, and movement (block 1110). For example, the computer system may receive, from a wearable device, physiological data of an animal, the physiological data including a heart rate, a body temperature, and movement, as described above.

As further shown in FIG. 11, process 1100 includes collecting visual data, and auditory data of the animal, the visual data including images and videos, and the auditory data including sounds and vocalizations (block 1120). For example, the computer system may collect visual data, and auditory data of the animal, the visual data including images and videos, and the auditory data including sounds and vocalizations, as described above.

As further shown in FIG. 11, process 1100 includes processing the physiological data, the visual data, and the auditory data to generate insights into an emotional state and a need of the animal (block 1130). For example, the computer system may process the physiological data, the visual data, and the auditory data to generate insights into an emotional state and a need of the animal, as described above.

As further shown in FIG. 11, process 1100 includes outputting the insights and an indication of the need (block 1140). For example, the computer system may output the insights and an indication of the need, as described above.

Process 1100 may include additional aspects, such as any single aspect or any combination of aspects described below and/or in connection with one or more other processes described elsewhere herein.

In a first aspect, the processing comprises deciphering and categorizing vocal cues of the animal in association with an ambient sound.

In a second aspect, alone or in combination with the first aspect, the processing comprises converting binary data generated by the environmental sensor by interpreting a data structure using a hexadecimal editor, a protocol analyzer, or a custom parsing script to decode the physiological data, the visual data, and the auditory data into a readable format.

In a third aspect, alone or in combination with one or more of the first and second aspects, process 1100 includes receiving user input for customizable notification preferences, and displaying, using the customizable notification preferences, a real-time alert on the user interface based on detection of an urgent event for the animal.

In a fourth aspect, alone or in combination with one or more of the first through third aspects, process 1100 includes auto-saving short video clips of specific behaviors of interest or concern.

Although FIG. 11 shows example blocks of process 1100, in some implementations, process 1100 includes additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
receiving, from at least two of a wearable device, a sensor, a camera, or a microphone, a multimodal data stream associated with real-time activity;
identifying a pattern of the real-time activity based on the multimodal data stream;
converting the pattern into a natural language prompt;
determining an interpretation of the real-time activity using the natural language prompt and a machine learning algorithm; and
outputting an indication of the interpretation through a user interface.

2. The computer-implemented method of claim 1, further comprising training the machine learning algorithm further using the multimodal data stream.

3. The computer-implemented method of claim 1, further comprising training the machine learning algorithm using the multimodal data stream and user corrections or annotations to improve accuracy of the machine learning algorithm.

4. The computer-implemented method of claim 1, wherein the real-time activity includes real-time activity of an animal, and wherein the identifying the pattern includes identifying a behavioral or physiological pattern of the animal based on the multimodal data stream.

5. The computer-implemented method of claim 4, wherein the interpretation includes an interpretation of an emotional or physical state of the animal, and wherein the machine learning algorithm is trained with a base dataset on animal behavior and physiology.

6. The computer-implemented method of claim 5, further comprising:
transmitting, to a centralized database, a log of historical data associated with behavioral or physiological patterns of animals, associated natural language prompts, and corresponding emotional or physical states; and
receiving, from the centralized database, information associated with long-term trends.

7. The computer-implemented method of claim 1, wherein the machine learning algorithm is trained using a combination of audio, visual, and physiological data from multiple sources.

8. The computer-implemented method of claim 1, wherein the determining includes recognizing patterns and correlations between different types of real-time activity data.

9. The computer-implemented method of claim 1, further comprising:
receiving feedback or recommendations that are personalized based on preferences and interaction patterns of a user.

10. The computer-implemented method of claim 1, further comprising:
communicating information about insights and experiences with other devices.

11. A computer system comprising:
a processor set; and
one or more computer-readable storage media program instructions stored on the one or more computer-readable storage media to cause the processor set to perform operations comprising:
receiving behavioral, auditory, and physiological data of an animal, from a wearable device, a camera, and a microphone;
determining an interpretation of an emotional state of the animal using the behavioral, auditory, and physiological data input into a machine learning algorithm;
outputting the interpretation through a user interface; and
continually adapting the machine learning algorithm through user feedback and new behavioral, auditory, and physiological data to improve interpretations of emotional states of animals.

12. The computer system of claim 11, wherein the wearable device includes one or more sensors to track real-time physiological changes in the animal, including heart rate variability and skin responses.

13. The computer system of claim 11, wherein the user interface is associated with a mobile application that displays the interpretation of the emotional state of the animal, offers notifications, and allows a user to provide feedback for the machine learning algorithm.

14. The computer system of claim 11, wherein the machine learning algorithm includes machine learning models that incorporate weather patterns and community-shared insights.

15. The computer system of claim 11, further comprising a feedback mechanism that enables a user to validate or correct interpretations of the emotional state.

16. A computer program product comprising:
one or more computer-readable storage media program instructions stored on the one or more computer-readable storage media to perform operations comprising:
receiving, from a wearable device, physiological data of an animal, the physiological data including a heart rate, a body temperature, and movement;
collecting, by an environmental sensor, visual data, and auditory data of the animal, the visual data including images and videos, and the auditory data including sounds and vocalizations;
processing, by a machine learning model, the physiological data, the visual data, and the auditory data to generate insights into an interpretation of an emotional state and a need of the animal; and
outputting, by a user interface, the insights and an indication of the need.

17. The computer program product of claim 16, wherein the processing comprises deciphering and categorizing vocal cues of the animal in association with an ambient sound.

18. The computer program product of claim 16, wherein the processing comprises converting binary data generated by the environmental sensor by interpreting a data structure using a hexadecimal editor, a protocol analyzer, or a custom parsing script to decode the physiological data, the visual data, and the auditory data into a readable format.

19. The computer program product of claim 16, further comprising:
receiving user input for customizable notification preferences; and
displaying, using the customizable notification preferences, a real-time alert on the user interface based on detection of an urgent event for the animal.

20. The computer program product of claim 16, further comprising:
auto-saving short video clips of specific behaviors of interest or concern.
